(19) United States
(12) Patent Application Publication
(10) Pub. No.: US 2015/0262496 A1
(43) Pub. Date: Sep. 17, 2015

(54) MULTIMEDIA EDUCATIONAL CONTENT DELIVERY WITH IDENTITY AUTHENTICATION AND RELATED COMPENSATION MODEL

(71) Applicant: Kadenze, Inc., Valencia, CA (US)

(72) Inventors: Perry Raymond Cook, Jacksonville, OR (US); Ajay Kapur, Valencia, CA (US); Owen S. Vallis, Valencia, CA (US); Jordan N. Hochenbaum, Valencia, CA (US)

(21) Appl. No.: 14/659,118

(22) Filed: Mar. 16, 2015

Related U.S. Application Data
(60) Provisional application No. 61/953,082, filed on Mar. 14, 2014.

(51) Int. Cl. G09B 5/06; H04L 29/06; G06Q 50/20; G09B 7/02; G06Q 40/00

(52) U.S. Cl. CPC G09B 5/06; G09B 7/02; G06Q 40/12; G06Q 50/205; H04L 63/083

(57) ABSTRACT

High-quality multimedia content of on-line course offerings can be made available to users on both a free-of-direct-charge basis and on a fee-bearing subscription, member or for-credit basis, while providing a revenue split with originators and/or sponsors of educational content. In general, such compensation models rely on computational techniques that reliably authenticate the identity of individual student users during the course of the very submissions and/or participation that will establish student user proficiency with course content.

### CROSS-REFERENCE

The present application claims benefit of U.S. Provisional Application No. 61/953,082, filed Mar. 14, 2014, the entirety of which is incorporated herein by reference.

### BACKGROUND

1. Field of the Invention

The present application is related to delivery of multimedia educational content and, in particular, to techniques for determining compensation metrics (e.g., for originators and/or sponsors of educational content) in correspondence with determinations of student populations for which student identity is reliably authenticated in the course of interactive submission of, or participation in, coursework.

2. Description of the Related Art

As educational institutions seek to serve a broader range of students and student situations, on-line courses have become an increasingly important offering. Indeed, numerous instances of an increasingly popular genre of on-line courses, known as Massive Open Online Courses (MOOCs), are being created and offered by many universities, as diverse as Stanford, Princeton, Arizona State University, the Berkeley College of Music, and the California Institute for the Arts. These courses can attract tens (or even hundreds) of thousands of students each. In some cases, courses are offered free of charge. In some cases, courses are offered for credit.

While some universities have created their own Learning Management Systems (LMS), a number of new companies have begun organizing and offering courses in partnership with universities or individuals. Examples of these include Coursera, Udacity, and edX. Still other companies, such as Moodle, offer LMS designs and services for universities who wish to offer their own courses.

Students taking on-line courses typically watch video lectures, engage in blog/chat interactions, and submit assignments, exercises, and exams. Submissions may be evaluated and feedback on quality of coursework submissions can be provided. In some cases, new educational business models are possible. To facilitate these new business models, technological solutions are needed. For example, in some cases, improved techniques are needed for reliably ascertaining or authenticating identity of a student user submitting assignments, exercises, and exams. In some cases, improved metrics are desired to facilitate compensation of originators and/or sponsors of educational content in a manner that reliably corresponds to actual subscribed and/or for-credit participation in the on-line coursework.

### SUMMARY

It has been discovered that high-quality multimedia content of on-line course offerings can be made available to users on both a free-of-direct-charge basis and on a fee-bearing subscription, member or for-credit basis, while providing a revenue split with originators and/or sponsors of educational content. In general, such compensation models rely on computational techniques that reliably authenticate the identity of individual student users during the course of the very submissions and/or participation that will establish student user proficiency with course content.

In some embodiments in accordance with the present invention(s), a method includes (1) providing multimedia educational content to users in an internetworking environment; (2) authenticating identity of individual users at least in part by computationally processing key sequence timings captured in connection with passphrase responses unique to the individual users, wherein the passphrase for a particular individual user is structured to include key sequences for which timings were computationally determined to be characteristic of the particular user; and (3) determining compensation for either or both of contributors and sponsors of the provided educational content based at least in part on a compensation metric that is based on population of users whose identity has been authenticated at least in part by the computational processing of the key sequence timings.

In some embodiments in accordance with the present invention(s), a method includes (1) providing multimedia educational content to users in an internetworking environment, the multimedia educational content including coursework requiring, at least for a subset of the users, interactive responses; (2) authenticating identity of individual users at least in part by computationally processing audio features extracted from user vocals captured in connection with the interactive responses; and (3) determining compensation for either or both of contributors and sponsors of the provided educational content based at least in part on a compensation metric that is based on population of users whose identity has been authenticated at least in part by the computational processing of the audio features.

In some embodiments in accordance with the present invention(s), a method includes (1) providing multimedia educational content to users in an internetworking environment, the multimedia educational content including coursework requiring, at least for a subset of the users, interactive responses; (2) authenticating identity of individual users at least in part by computationally processing image processing features of images or video of the individual users captured in connection with the interactive responses; and (3) determining compensation for either or both of contributors and sponsors of the provided educational content based at least in part on a compensation metric that is based on population of users whose identity has been authenticated at least in part by the computational processing of the image processing features.

In some embodiments in accordance with the present invention, a method includes a method includes (1) providing multimedia educational content to users in an internetworking environment, the multimedia educational content including coursework requiring, at least for a subscribing subset of the users, interactive responses from the users; (2) authenticating identity of individual users from the subscribing subset of users at least in part by computationally processing at least one of (i) key sequence timings captured in connection with the interactive responses by the individual users, (ii) audio features extracted from user vocals captured in connection with the interactive responses and (iii) image processing features of images or video of the individual users captured in connection with the interactive responses; and (3) determining compensation for either or both of contributors and sponsors of the provided educational content based at least in part on a compensation metric that is based on population of users, from the subscribing subset thereof, whose identity has been authenticated at least in part by the computational processing of the key sequence timings, the captured audio features or the images or video captured in connection with the interactive responses.

In some cases or embodiments, the population of users on which the compensation metric is based is a set of users determined, at least in part based on the interactive responses, to be active users. In some cases or embodiments, the population of users on which the compensation metric is based excludes those users determined to be inactive.

In some embodiments, the method further includes determining the active set of users based on one or more of: submission of assignments by the user, completion of quizzes or tests, and participation in user forums.

In some cases or embodiments, the compensation metric includes allocation of a predetermined non-zero share of member or subscription fees to the contributors or sponsors of the provided educational content with respect to which a particular user is determined to be active. In some cases or embodiments, the compensation metric includes allocation of a predetermined non-zero share of fees to the contributors or sponsors of the provided educational content with respect to which a particular user is registered for credit.

In some cases or embodiments, the identity authenticating includes computationally evaluating correspondence of the captured key sequence timings with key sequence timings previously captured for, and previously determined to be, characteristic of a particular user. In some embodiments, the method further includes capturing the key sequence timings for the particular user and computationally determining particular ones of the key sequence timings to be characteristic of the particular user. In some cases or embodiments, the key sequence timing capture is performed, at least in part, as part of enrollment of the particular user. In some embodiments, the method still further includes creating a passphrase for the particular user, wherein the created passphrase is structured to include key sequences for which timings were computationally determined to be characteristic of the particular user.

In some cases or embodiments, the identity authenticating includes computationally evaluating correspondence of the captured vocal features with vocal features previously captured for, and previously determined to be, characteristic of a particular user. In some embodiments the method further includes capturing the vocal features for the particular user and computationally determining particular ones of the vocal features to be characteristic of the particular user. In some cases or embodiments, the vocal feature capture is performed, at least in part, as part of enrollment of the particular user.

In some cases or embodiments, the identity authenticating includes computationally evaluating correspondence of the captured image processing features with features previously captured for, and previously determined to be, characteristic of a particular user. In some embodiments, the method further includes capturing the image processing features for the particular user and computationally determining particular ones of the image processing features to be characteristic of the particular user. In some cases or embodiments, the image processing feature capture is performed, at least in part, as part of enrollment of the particular user.

In some embodiments, the method still further includes providing the particular user with an on-screen game or task and during the on-screen game or task capturing the image processing features. The on-screen game or task provides a user interface mechanism by which movement, by the particular user, of his or her face within a field of view of visual capture device is used to advance the particular user through the on-screen game or task.

In some cases or embodiments, the identity authentication is multi-modal. In some embodiments the method further includes computationally evaluating correspondence of at least some of the captured image processing features with captured vocals.

In some cases or embodiments, the compensation metric allocates either or both of member/subscription fees and tuition. In some cases or embodiments, the contributors include educational content originators and/or instructors. In some cases or embodiments, the sponsors include educational institutions, testing organizations and/or accreditation authorities. In some embodiments, the method further includes compensating either or both of the contributors and sponsors based on the determined compensation metric.

In some cases or embodiments, a computational system including one or more operative computers is programmed to perform at least one of the preceding methods. In some cases or embodiments, the computational system is embodied, at least in part, as a network deployed coursework submission system, whereby a large and scalable plurality (>50) of geographically dispersed students may individually submit their respective coursework submissions in the form of computer readable information encodings. In some cases or embodiments, a non-transient computer readable medium encodes instructions executable on one or more operative computers to perform at least one of the preceding methods.

In some embodiments in accordance with the present invention(s), a learning management system includes one or more multimedia educational content stores, a biometrically-based user authentication mechanism and an administration module. The one or more multimedia educational content stores are network-accessible and configured to serve a distributed network-connected set of content delivery devices with multimedia educational content including interactive content requiring, at least for a subscribing subset of the users, interactive responses. The biometrically-based user authentication mechanism is configured to authenticate identity of individual users from the subscribing subset of users at least in part by computationally processing one or more of (i) key sequence timings, (ii) audio features extracted from user vocals and (iii) image processing features of images or video of the individual users, each captured, for a respective user from the subscribing subset of users, at a respective content delivery device in connection with the interactive responses by the respective user to the multimedia educational content served from the network-accessible content stores. The administration module is configured to maintain records data for individual users from the subscribing subset of users and coupled to receive from the biometrically-based user authentication mechanism indications that, in the course of interactive responses by respective users to the multimedia educational content served from the network-accessible content stores, particular users from the subscribing subset of users have been authenticated. The administration module is further configured to determine compensation for either or both of contributors and sponsors of the served educational content based on a compensation metric that is based at least in part on an active population of users, from the subscribing subset thereof, whose identity has been authenticated at least in part by the computationally processing of the key sequence timings, the captured audio features or the images or the video captured in connection with the interactive responses.

### BRIEF DESCRIPTION OF THE DRAWINGS

The present invention(s) are illustrated by way of example and not limitation with reference to the accompanying drawings, in which like references generally indicate similar elements or features.

FIG. 1 depicts an illustrative networked environment including a coursework management system that provides student users with multimedia educational content and which may, in accordance with some embodiments of the present invention(s) and in furtherance of a contributor or sponsor compensation model, authenticate identity of users based on features extracted from interactive responses.

FIG. 2 depicts data flows for, interactions with, and operational dependencies of, various components of a coursework management system such as that depicted in FIG. 1 which, in some embodiments, may provide automated coursework evaluations for test, quiz or other coursework submission from at least a subset of users whose identities have been reliably authenticated.

FIG. 3 depicts data flows for, interactions with, and operational dependencies of, various components of a coursework management system such as that depicted in FIG. 1 which, in some embodiments in accordance with the present invention(s), authenticates identity of at least a subset of student users based on features extracted from interactive responses from such users.

FIG. 4 is a flowchart depicting a three-phase, facial recognition algorithm executable in, or in connection with, image/video-type feature extraction and classification operations to authenticate identity of a particular user consistent with the flows depicted in FIG. 3.

FIG. 5 is a flowchart depicting an algorithm executable in, or in connection with, key sequence timing-type feature extraction and classification operations to authenticate identity of a particular user consistent with the flows depicted in FIG. 3.

FIG. 6 notionally illustrates dwell time and flight time features extracted from keystroke data.

FIG. 7 illustrates a data structure employed in some realizations of algorithms for key sequence timing-type feature extraction and classification operations to authenticate user identity.

FIG. 8 depicts code suitable for key sequence timing-type feature extraction to facilitate authentication of user identity in some coursework management system embodiments of the present invention(s).

FIG. 9 is a flowchart depicting an algorithm executable in, or in connection with, voice-type audio feature extraction and classification operations to authenticate identity of a particular user consistent with the flows depicted in FIG. 3.

### DESCRIPTION

The solutions described herein address problems newly presented in the domain of educational coursework, administration and testing, such as for on-line courses offered for credit to large and geographically dispersed collections of students (e.g., over the Internet), using technological solutions including computational techniques for feature extraction and student user authentication based on captured features of student responses to interactive content. In some cases or embodiments, timing of keystroke sequences captured in the course of typed responses and/or computationally-defined audio (e.g., vocal) and/or image/video (e.g., facial) features captured via microphone or camera may be used to reliably authenticate identity of a student user. In this way, coursework submissions (e.g., test, quizzes, assignments, participation in class discussions, etc.) may be auto-proctored in a manner that allows sponsoring institutions to provide or assign credit and credence to student performance.

We envision on-line course offerings that are available to users on both (1) a free-of-direct-charge basis and (2) a fee-bearing subscription, member or for-credit basis. In general, student-users can avail themselves of university-level, credit-granting courses online. They can watch the lectures for free. In some cases, student-users can even do the assignments and participate in the discussion forums. However, if they want their assignments graded and/or if they want other premium benefits, a member/subscriber tier is available.

Premium benefits can include instructor- or teaching assistant-based feedback on coursework submissions, member or “for-credit” student status in discussion forums, discounts on software, hardware, text books, etc. In some cases, premium member/subscriber tier benefits may include the reporting of a verifiable level of achievement to an employer or university (e.g., John Q. Student finished 5^{th}, or in the 5^{th} percentile, in Introduction to Multiplayer Game Development and Coding, offered by a particular and prestigious university) or as a certification mark for an on-line resume, professional networking site or job-recommendation service.

Member/subscriber tier premium benefits may, in some cases, include the ability to take course(s) for actual university credit, even as a high-school student or younger. As a result, and in some cases, Advanced Placement courses, exams, and credit start to look less attractive in comparison to actual credit that can transfer into or across schools.

For at least some of these premium services, technological solutions are needed or desirable to implement the membership system, to auto-proctor coursework submissions and reliably authenticate identities of users in the course of coursework submissions and/or class participation. Preferably, biometrically-based authentication techniques are used to reduce risks of student impersonators and “hired-gun” or proxy test taker schemes to procure credit. Due to the interactive nature of coursework submissions and class participation, and due to the general absence of practical physical location and physical presence based proctoring options for on-line courses, we tend to emphasize biometrics that can be captured from or extracted from actual coursework submissions and/or on-line class participation. For example, computational processing of:
(i) key sequence timings captured in connection with the interactive responses by the individual users;
(ii) audio features extracted from user vocals captured in connection with the interactive responses; and/or
(iii) images or video of the individual users captured in connection with the interactive responses,
   may be employed to reliably authenticate the identity of the actual student user during the course of the very submissions and/or participation that will establish student user proficiency with course content. In many cases, authentication (and indeed the collection of student user characteristic biometrics) is covert and need not be readily apparent to the student user.

Note that in many cases and implementations, in addition to the member/subscriber tier premium benefits provided to authenticable users, unauthenticated “auditing” of course content may also (and typically will) be provided, though not for credit, employer reporting, certification, etc. In some cases, authenticated member/subscriber tier users may be offered the opportunity to “wait-and-see” how they perform, before requesting actual university credit, employer reporting or certification.

Building on a biometrically-based authentication infrastructure, new revenue models and compensation metrics for originators and/or sponsors of educational content have been developed. For example, in some embodiments, compensation metrics for originators and/or sponsors of educational content are determined as a function of user populations for which identity is reliably authenticated in the course of interactive submission of, or participation in, coursework. For example, in some cases, at the end of a period (year, semester, etc.), we do an accounting of how many member/subscriber tier users were active in each course. Revenue is distributed and/or split based on the active user base.

In general, users cannot just watch videos to be “active.” Instead, multimedia lesson content typically will include quizzes or other coursework requiring interactive responses. Quizzes and other coursework are typically embedded in a lesson or presented between lessons. In some cases, automated grading technology tracks student progress, possibly not letting a student progress to the next lesson/video until he or she has proven some level of mastery by way of interactive responses. In some cases the system may simply require the user to demonstrate that he or she has paid attention, again by way of interactive responses. In each case, features captured or extracted from the interactive responses (or at least from some of the interactive responses) may be computationally evaluated for correspondence with biometrics characteristic of the member/subscriber tier user that the student purports to be.

In general, member/subscriber tier users participating for credit must complete the assignments, finish the course, and possibly even participate in user forums. Although different implementations may employ different completion criteria, on balance, many implementations will seek to achieve some balance between ensuring that interested students are retained and assuring sponsoring institutions both that the retained active students really participated in their course(s) and that, for each such active student, his/her identity has been reliably authenticated throughout interactive submissions (including graded quizzes, test and other coursework). For credit, criteria typically include completion of all the interactive response requiring coursework/assignments and demonstrating target levels of proficiency by way of interactive quizzes and/or exams. For member/subscribing users not participating for credit, some lesser set of criteria may be employed.

Based on the active user population data analytics, we pay out a revenue split to each sponsoring institution and/or each instructor (or other content originator). Typically, revenue splits are calculated after backing out per-member/participant expenses, although any of a variety of expense allocations is possible. In general, a revenue base may include member/subscription fees, a portion of revenue from purchases of software, hardware, text books, etc., value-added services such as grading/feedback for supplemental content or exercises, even advertising revenue. In the case of active users for-credit, tuition and related fees may be included in a revenue base.

Although any of a variety of revenue splits may be desirable or negotiated based on quality of educational content, the compensation metrics are anchored in the population of active users, where active users are reliably authenticable based on biometric information captured or extracted during the course of the very submissions and/or participation that establish student user proficiency with course content. In this way, fraud risks are greatly reduced. In addition, the use of authenticated active user based metrics for compensation of originators and/or sponsors of educational content tends to incentivize creators and sponsors of quality educational content and monetize member/subscriber tier premium services, all while managing and preserving a free-access model for a subset of the user base.

### Illustrative Coursework Management Systems

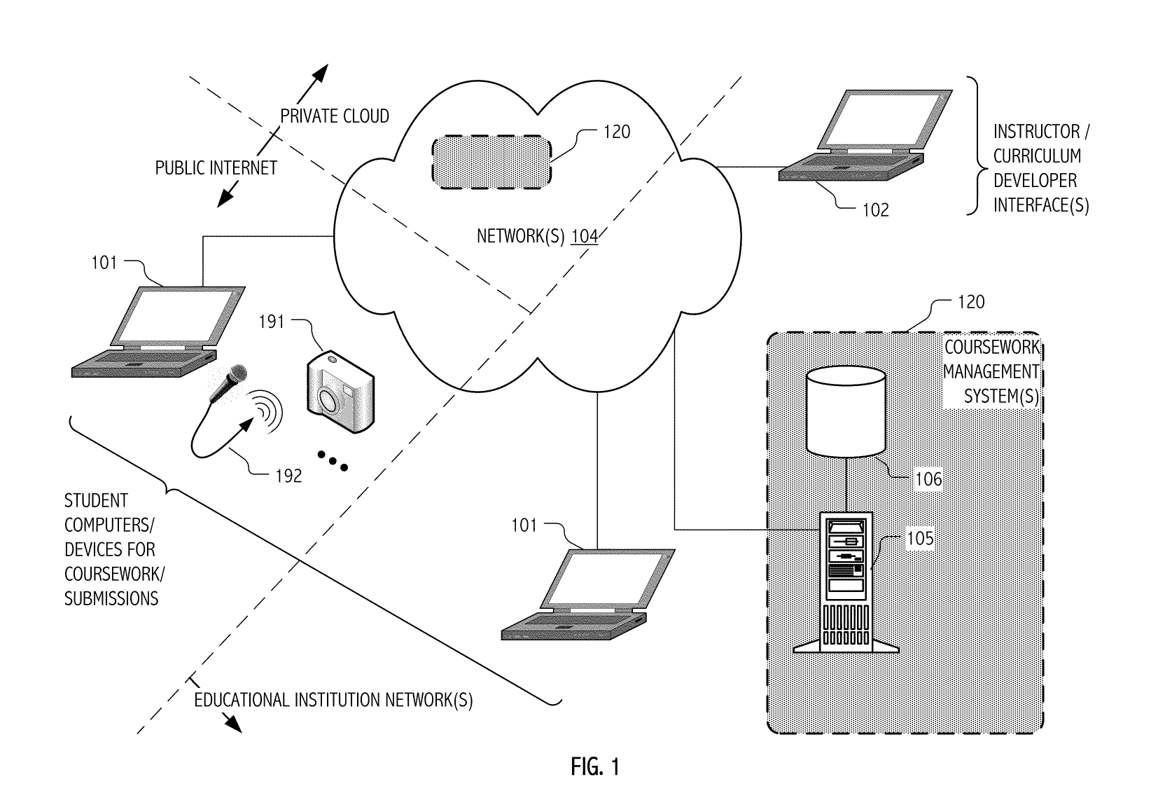

FIG. 1 depicts an illustrative networked information system in which students and instructors (and/or curriculum developers) interact with coursework management systems 120. In general, coursework management systems 120 such as described herein may be deployed (in whole or in part) as part of the information and media technology infrastructure (networks 104, servers 105, workstations 102, database systems 106, including e.g., audiovisual content creation, design and manipulation systems, code development environments, etc. hosted thereon) of an educational institution, testing service or provider, accreditation agency, etc. Coursework management systems 120 such as described herein may also be deployed (in whole or in part) in cloud-based or software-as-a-service (SaaS) form. Students interact with audiovisual content creation, design and manipulation systems, code development environments, etc. deployed (in whole or in part) on user workstations 101 and/or within the information and media technology infrastructure. In many cases, audiovisual performance and/or capture devices (e.g., still or motion picture cameras 191, microphones 192, 2D or 3D scanners, musical instruments, digitizers, etc.) may be coupled to or accessed by (or from) user workstations 101 in accordance with the subject matter of particular coursework and curricula.

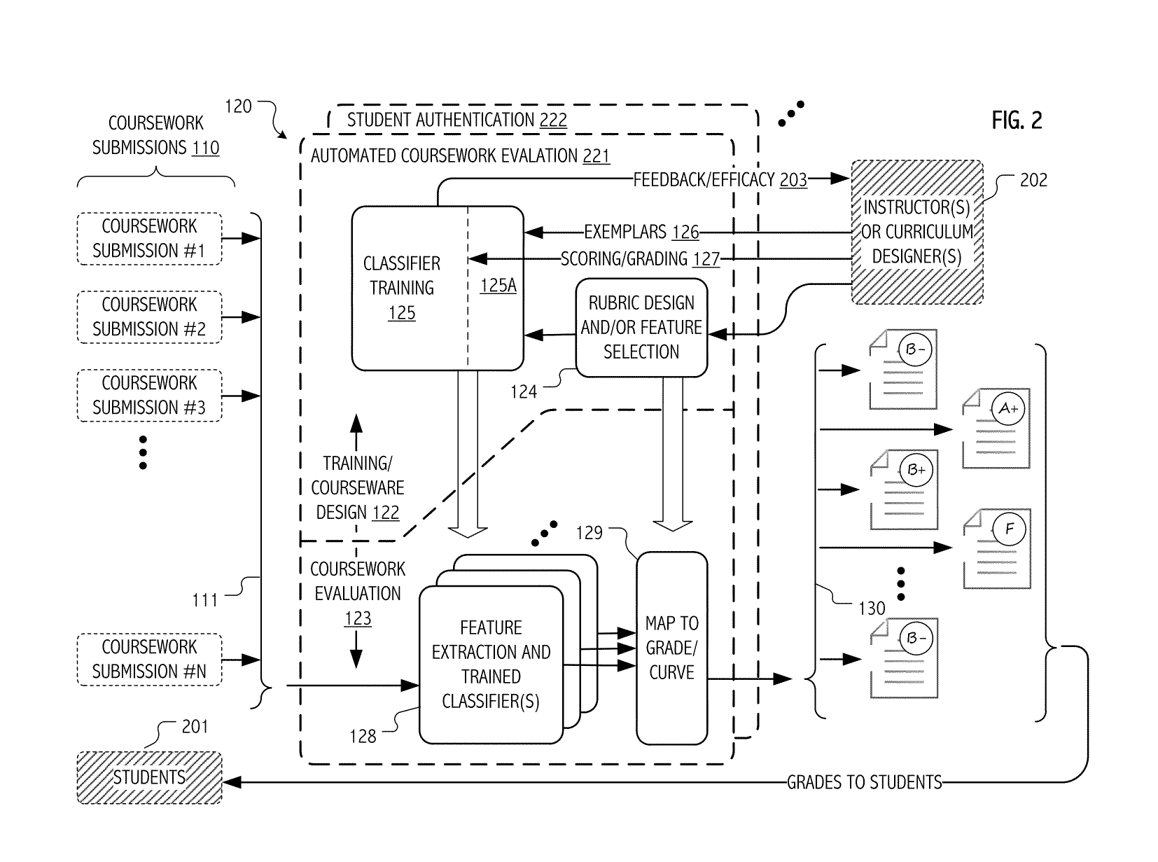

FIG. 2 depicts data flows, interactions with, and operational dependencies of various components of an instance of coursework management system 120 that includes an automated coursework evaluation subsystem 221 and a student authentication subsystem 222 in accordance with some embodiments of the present invention(s).

Automated coursework evaluation subsystem 221 includes a training/courseware design component 122 and a coursework evaluation component 123. An instructor and/or curriculum designer 202 interacts with the training/courseware design component 122 to establish (for given coursework such as a test, quiz, homework assignment, etc.) a grading rubric (124) and to select related computationally-defined features (124) that are to be used to characterize quality or scoring (e.g., in accordance with criteria and/or performance standards established in the rubric or ad hoc) for coursework submissions by students.

For example, in the context of an illustrative audio processing assignment, a rubric may define criteria including distribution of audio energy amongst selected audio sub-bands, degree or quality of equalization amongst sub-bands, degree of panning for mixed audio sources and/or degree or quality of signal compression achieved by audio processing. In the context of an illustrative image or video processing assignment, a rubric may define criteria for tonal or chromatic distributions, use of focus or depth of field, point of interest placement, visual flow and/or quality of image/video compression achieved by processing. Based on such rubrics, or in accord with ad hoc selections by instructor and/or curriculum designer 202, particular computationally-defined features are identified that will be extracted (typically) based on signal processing operations performed on media content (e.g., audio signals, images, video, digitized 3D surface contours or models, etc.) and used as input feature vectors in a computational system implementation of a classifier. Instructor and/or curriculum designer 202, also supplies (or selects) media content exemplars 126 and scoring/grading 127 thereof to be used in classifier training 125.

In general, any of a variety of classifiers may be employed in accordance with statistical classification and other machine learning techniques that exhibit acceptable performance in clustering or classifying given data sets. Suitable and exemplary classifiers are identified herein, but as a general proposition, in the art of machine learning and statistical methods, an algorithm that implements classification, especially in concrete and operative implementation, is commonly known as a “classifier.” The term “classifier” is sometimes also used to colloquially refer to the mathematical function, implemented by a classification algorithm that maps input data to a category. For avoidance of doubt, a “classifier,” as used herein, is a concrete implementation of statistical or other machine learning techniques, e.g., as one or more of code executable on one or more processors, circuitry, artificial neural systems, etc. (individually or in combination) that processes instances explanatory variable data (typically represented as feature vectors extracted from instances of data) and groups the instances into categories based on training sets of data for which category membership is known or assigned a priori.

In the terminology of machine learning, classification can be considered an instance of supervised learning, i.e., learning where a training set of correctly identified observations is available. A corresponding unsupervised procedure is known as clustering or cluster analysis, and typically involves grouping data into categories based on some measure of inherent statistical similarity uninformed by training (e.g., the distance between instances, considered as vectors in a multi-dimensional vector space). In the context of the presently claimed invention(s), classification is employed. Classifier training is based on instructor and/or curriculum designer inputs (exemplary media content and associated grading or scoring), feature vectors used characterize data sets are selected by the instructor or curriculum designer (and/or in some cases established as selectable within a training/courseware design module of an automated coursework evaluation system), and data sets are, or are derived from, coursework submissions of students.

Based on rubric design and/or feature selection 124 and classifier training 125 performed (in training/courseware design component 122) using instructor or curriculum designer 202 input, feature extraction techniques and trained classifiers 128 are deployed to coursework evaluation component 123. In some cases, a trained classifier is deployed for each element of an instructor or curriculum designer defined rubric. For example, in the audio processing example described above, trained classifiers may be deployed to map each of the following: (i) distribution of audio energy amongst selected audio sub-bands, (ii) degree or quality of equalization amongst sub-bands, (iii) degree of panning for mixed audio sources and (iv) degree or quality of signal compression achieved by audio processing to quality levels or scores based on training against audio signal exemplars. Likewise, in the image/video processing example described above, trained classifiers may be deployed to map each of the following: (i) distribution of tonal or chromatic values, (ii) focus or depth of field metrics, (iii) positioning or flow with a visual field of computationally discernible points/regions of interest and (iv) degree or quality of image/video compression to quality levels or scores based on training against image or video content exemplars. In some cases, features extracted from media-rich content 111 that constitutes, or is derived from, coursework submissions 110 by students 201 are used as inputs to multiple of the trained classifiers. In some cases, a single trained classifier may be employed, but more generally, outputs of multiple trained classifiers are mapped to a grade or score (129), often in accordance with curve specified by the instructor or curriculum designer.

Resulting grades or scores 130 are recorded for respective coursework submissions and supplied to students 201. Typically, coursework management system 120 includes some facility for authenticating students, and establishing, to some reasonable degree of certainty, that a particular coursework submission 110 is, in fact, submitted by the student who purports to submit it. Student authentication may be particularly important for course offered for credit or as a condition of licensure.

In some embodiments of coursework management system 120 (see e.g., FIG. 2), an automated coursework evaluation subsystem 121 may cooperate with student authentication facilities, such as fraud/plagiarism detection. For example, if coursework submissions (ostensibly from different, separately authenticated students) exhibit exactly or nearly the same score(s) based on extracted computationally defined features and classifications, then fraud or plagiarism is likely and can be noted or flagged for follow-up investigation. Likewise, if a coursework submission exhibits exactly the same score(s) (again based on extracted computationally defined features and classifications) as a grading exemplar or model audio signal, image, video or other expressive media content supplied to the students as an example, then it is likely that the coursework submission is, in-fact, a submission of the example, rather than the student's own work. Based on the description herein, persons of skill in the art will appreciate these and other benefits of integrating student authentication and automated coursework evaluation facilities in some embodiments of a coursework management system.

While neither automated coursework evaluation, nor media-rich coursework such as described above, are essential in all cases, situations or embodiments in accord with the present invention(s), the above-described techniques are illustrative of techniques employed in at least some embodiments. Additional techniques are detailed in commonly-owned, co-pending U.S. application Ser. No. 14/461,310, filed 15 Aug. 2014, entitled “FEATURE EXTRACTION AND MACHINE LEARNING FOR EVALUATION OF IMAGE- OR VIDEO-TYPE, MEDIA-RICH COURSEWORK” and naming Kapur, Cook, Vallis, Hochenbaum and Honigman as inventors , the entirety of which is incorporated herein by reference.

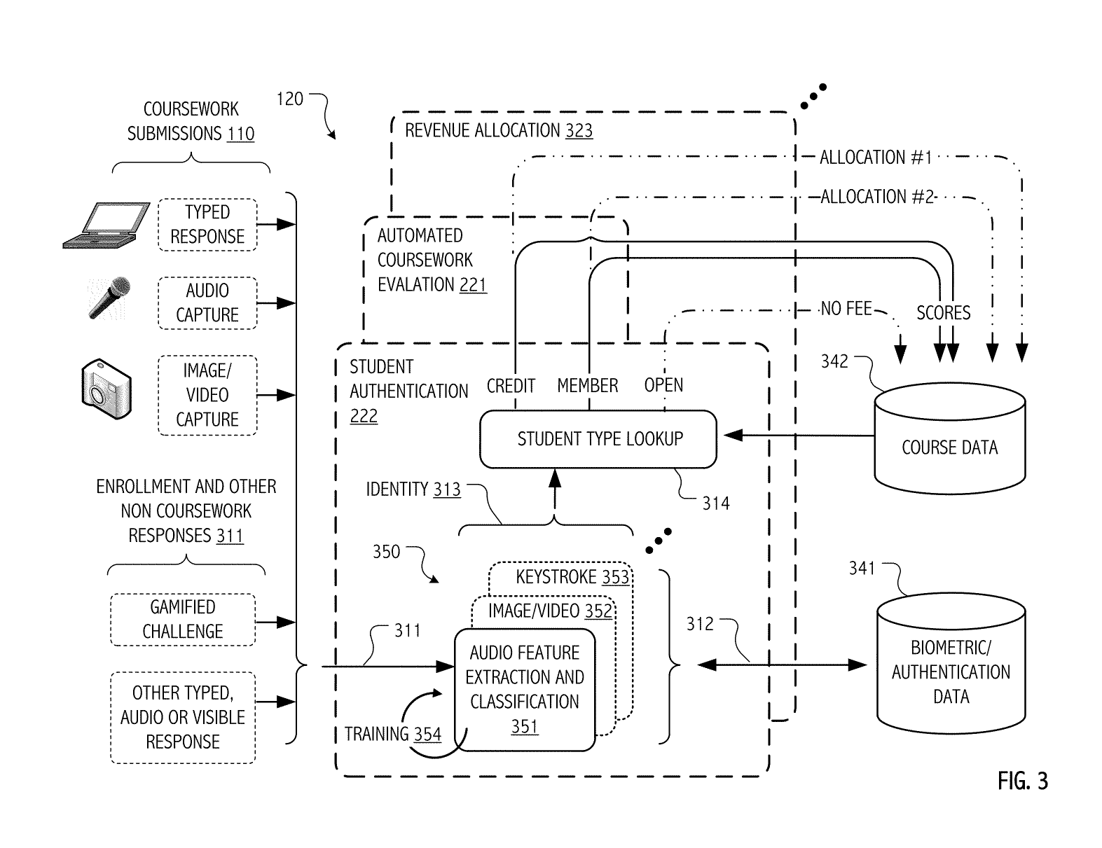

FIG. 3 depicts further data flows, interactions with, and operational dependencies of various components of an instance of coursework management system 120 that includes the above-described automated coursework evaluation subsystem 221 as well as a student authentication subsystem 222 in accordance with some embodiments of the present invention(s) to facilitate allocations of revenue (323) to originators of coursework (e.g., instructors and/or curriculum designers), sponsoring educational institutions, etc. Like automated coursework evaluation subsystem 221, student authentication subsystem 222 employs computational techniques to extract features from user content and to perform classification. However, unlike the feature extraction and classification performed in automated coursework evaluation subsystem 221, the features selected for extraction and classification in student authentication subsystem 222 are biometrically indicative of identity of the user who submits particular coursework or otherwise responds to coursework supplied in coursework management system 120.

In general, any of a variety of biometrically indicative responses 311 may be employed by respective feature extraction and classification computations 350 to train (354) respective classifiers 350 and thereafter authenticate identify (311) of a student user. The set and usage (including, in some cases or embodiments, for multi-modal authentication) of particular features and classifiers is, in general, implementation dependent; however, in the illustrated implementation, features are extracted from one or more biometrically indicative responses 311 and processed using one or more of audio feature extraction and classification 351, image/video feature extraction and classification 352 and/or keystroke timing feature extraction and classification 353. Training (354) can be performed as part of a student enrollment process and/or during course administration. Resulting indicative data is stored (312) in biometric/authentication data store 341 for subsequent retrieval (312) and use in authentication.

Sets of computational features extracted from biometrically indicative responses 311 and particular classification techniques employed to authenticate identity (313) of a particular user are each described in greater detail below. Such authentication may be multi-modal in nature, as described in commonly-owned, co-pending Provisional Application No. 62/000,522, filed May 19 2014, entitled “MULTI-MODAL AUTHENTICATION METHODS AND SYSTEMS” and naming Cook, Kapur, Vallis and Hochenbaum as inventors, the entirety of which is incorporated herein by reference. On the other hand, multimodal techniques need not be employed in all cases, situations or embodiments, and single mode authentication of identity (313), e.g., based simply on audio feature extraction and classification 351, or image/video feature extraction and classification 352 or keystroke timing feature extraction and classification 353, may be desirable and effective in some embodiments. However, for purposes of descriptive context and without limitation, each such modality is illustrated in FIG. 3.

Also illustrated in FIG. 3 is a rich set of biometrically indicative responses 311 from which particular responses may be selected for feature extraction and classification. Such illustrative responses may include coursework (110) and/or non-coursework (310) responses. For example, coursework submissions (110) themselves, e.g., in the form of typed user responses, user vocals and/or still or moving images, may be captured in response to coursework supplied by coursework management system 120. Such responses, e.g., key sequences typed by the user, a voiced response by the user and/or image(s) of the user captured in the course of a submission, may contain biometrically indicative data that are extractable for classification and use in authenticating identity. In some cases, capture of biometrically indicative responses 311 is covert and is not discernible by the user. For example, coursework management system 120 may require that responses to certain test or quiz questions be voiced or typed, and user responses may be used as both a substantive response for the purpose of grading and for authentication. Likewise, audio, image/video or typed responses in the context of a user forum or discussion group may be captured and conveyed overtly to other participants, while also being used for covert authentication of the participant's identity.

On the other hand, in some cases, situations or embodiments, interactive responses (be they typed, voiced or based on image/video capture) may be in response to a more overt authentication request, such as:
“For authentication, please type your passphrase now” [a typed response] or
“For authentication, please center the image of your face in the on-screen box and state your name” [and audio and visible response] or
“For authentication, please move the on-screen character along the path illustrated by orienting your head upward, downward and from side to side” [a “gamified” challenge response].

Based on coursework or non-coursework responses and particular feature extraction and classification techniques employed, student authentication subsystem 222 uses the biometrically indicative responses 311 to authenticate identity (313) of a particular student user so that coursework submissions by that student user and grades or scores attributable thereto may be appropriately credited. For purposes of illustration, a separate lookup (314) of student data in a separate course data store 342 is shown, although in some implementations, a combined database or store may be employed. Based on the authenticated identity (313) and on course data 342 maintained for a user whose identity has been authenticated, it is possible to determine (e.g., by student type lookup) whether the particular user (i) is enrolled for credit with a particular sponsoring institution or body, (ii) is a member or subscriber, or (iii) is merely auditing the course (or a unit thereof) as part of an open, non-fee-bearing enrollment. Note that, in some cases, situations or embodiments, a user auditing or participating as part of an open, non-fee-bearing enrollment, need not even be authenticated, and users who fail to authenticate may simply be treated as such.

As illustrated in FIG. 3, participation credit and coursework evaluation (e.g., scoring of tests, quizzes, assignments, etc.) whether automated (by automated coursework evaluation 221) or based on human review, is typically provided only to fee-bearing users (e.g., those enrolled for credit or under a membership agreement). Semester, unit or course grades and ultimately credit or certification are typically reserved to fee bearing users as well. Correspondingly, revenues associated with fee-bearing students may be allocated (323) and credited to stakeholders on a unit, coursework submission, semester or other basis based on the type of user for which identity has been reliably authenticated.

For example, in the case of a user who has been reliably authenticated as a participant for credit at a sponsoring educational institution, revenue may be allocated amongst (i) the sponsoring educational institution, (ii) an originator (or originators) of the particular course (e.g., an author, professor/instructor and/or curriculum designer) and (iii) an on-line content or courseware provider in accordance with a first allocation (perhaps 45%, 5%, 50%). On the other hand, for another user who has been authenticated (while participating in the very same course) as a member participating under a membership agreement with, for example, the on-line content or courseware provider, a second allocation (perhaps 20%, 5%, 75%) may be used. Free auditing by still other users may, and typically is, also provided without revenue allocation. In general, the particular shares or allocations of revenue and, indeed, particular participants in any such revenue allocation (323) are matters of negotiation and business choice.

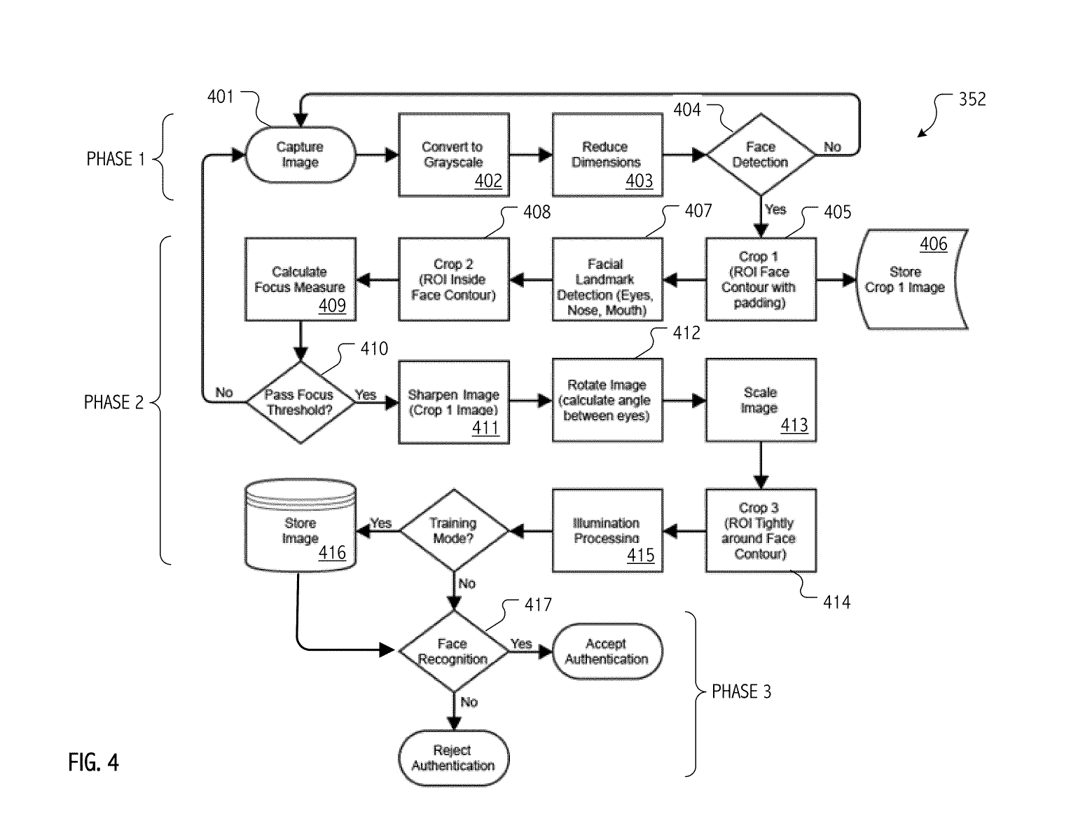

Turning next to FIGS. 4, 5 and 9, exemplary user enrollment and identity authentication algorithms are described for facial recognition-type image/video feature extraction and classification 352, for keystroke timing feature extraction and classification 353, and for voiceprint-type audio feature extraction and classification 351. The algorithms are executable in the above-described coursework management system 120 with functionality distributed (as a matter of design choice in any given implementation) amongst server-, cloud- and even workstation-resident computational facilities. Each such algorithm is described in succession and in greater detail below.

### Facial Recognition Features and Classification

FIG. 4 is a flowchart depicting a three-phase, facial recognition algorithm executable in, or in connection with, image/video-type feature extraction and classification operations to authenticate identity of a particular user in the flows depicted in FIG. 3. In a first (pre-processing) phase, an image of the user's face is captured (401), typically using a user-workstation resident camera or mobile phone. Next, the captured image is converted (402) to an 8-bit unsigned grayscale image and dimensionally reduced (403) to make pre-processing more efficient. Next, a Viola-Jones (Haar Cascade) classifier attempts to recognize (404) the presence of a face within the image. If a face is detected, the computation proceeds to phase 2. Otherwise, another image capture is attempted and the phase 1 process is retried. In some embodiments, phase 1 processes are performed on a workstation resident processor based on, for example, code demand-supplied from a cloud- or server-resident service platform.

Phase 2 deals primarily with aligning and cropping the image for consistency and to establish a region of interest (ROI) within the captured image. First, the image is cropped (crop 1, 405) around the detected face region (that determined in phase 1 and containing the face contour), and stored (406) for later use. A facial landmark detector (407) determines areas of interest in this region (eyes, nose, mouth, etc.) and their positions are used to make a tighter crop region inside the face. One suitable implementation of facial landmark detector 407 employs a flandmarks algorithm available open source for facial landmark detection, though alternative implementations may employ active appearance models (AAMs), active shape models ASMs, or Viola-Jones Haar cascades for facial landmark detection. Using this facial landmark defined region (crop 2, 408), a focus measure can be calculated (409) to measure blurriness of the facial region of the image. If this region fails to pass a focus threshold check (410), another image capture is attempted and the process is retried for the newly captured image, beginning with phase 1. However, if image focus is acceptable (or if pruning based on a focus threshold violation is disabled), a sharpening filter is applied to subtly sharpen the image and improve contrast in facial features and contours.

Next, the angle between the eyes (determined from the center of each eye interpolated from the eye corners detected using the facial landmark detector) is calculated and used to rotate (412) the image for frontal pose alignment. Additionally, in some implementations, a low-pass (LP) smoothing filter is employed on the eye locations as facial landmark detection is used to recalculate landmarks within each frame, without incorporating the previously calculated facial landmark positions. Next, the image is scaled (413) and cropped (414), based on the (recalculated) facial landmarks. Lastly, additional illumination processing (415, using a Tan-Triggs technique) is applied to reduce the impact of variable illumination in the image and environment. Phase 2 processing seeks to achieve sufficient alignment, scale and illumination consistency between images captured and processed for different subjects to support phase 3 recognition.

When performed as part of a user enrollment or training mode, the result of phase 2 processing is stored in library 416 for use in subsequent identity authentication in the course of coursework submissions. When performed as part of identity authentication in the course of coursework submissions, further processing seeks to recognize the result of phase 2 processing based on the stored library of images.

Lastly, phase 3 recognition (417) attempts to recognize the face against trained images in library 416 of biometric/authentication data store 341 (recall FIG. 3). In some embodiments, a local binary patterns histogram (LBPH) technique is used for face recognition. Using this technique, a distance measure is reported, which can be used as a degree of confidence. An optional threshold parameter is employed for Boolean (true/false) recognition. Fisher Faces and/or Eigenfaces techniques may be employed as an alternative to LBPH in some cases, situations or embodiments. Likewise, alternative embodiments may employ deep learning, specifically convolutional neural network (CNN) techniques, for the face recognition 417.

### Keystroke Timing Features and Classification

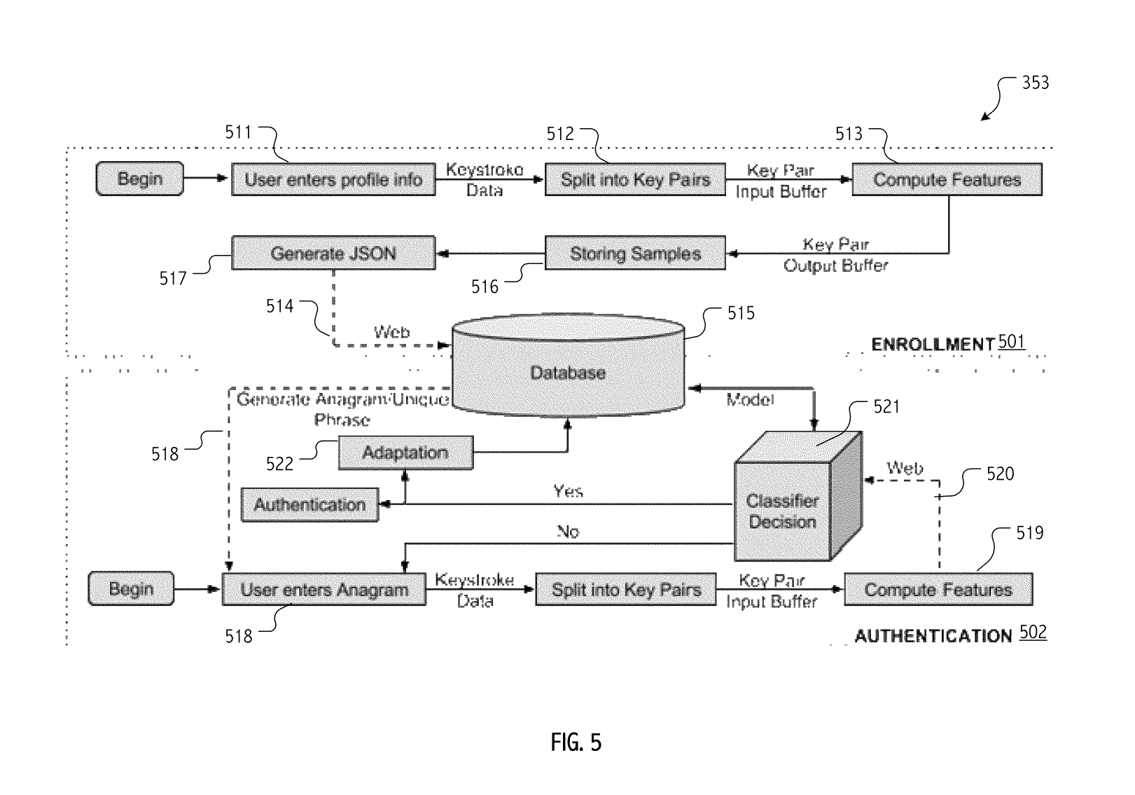

FIG. 5 is a flowchart depicting an algorithm executable in, or in connection with, key sequence timing-type feature extraction and classification operations to authenticate identity of a particular user in the flows depicted in FIG. 3. As before, the algorithm includes both enrollment (501) and authentication (502) portions and, as before, initial capture of biometrically indicative data (here of keystroke data including dwell and flight times) may be performed (at least in part) on a workstation-resident processor based on, for example, code that is demand-supplied from a cloud- or server-resident service platform.

As part of enrollment 501, the user enters (511) textual content, e.g., as part of user profile entry or in response to some direction from coursework management system 120. Web-based application code executing locally at the user's workstation (e.g., workstation 101, recall FIG. 1) splits (512) the incoming keystroke data into pairs and computes (513) a set of features per key pair that are then used to generate the user's keyboard biometric distributions. These features are stored as a JSON file, sent to a cloud- or server-resident, and later used during the authentication session.

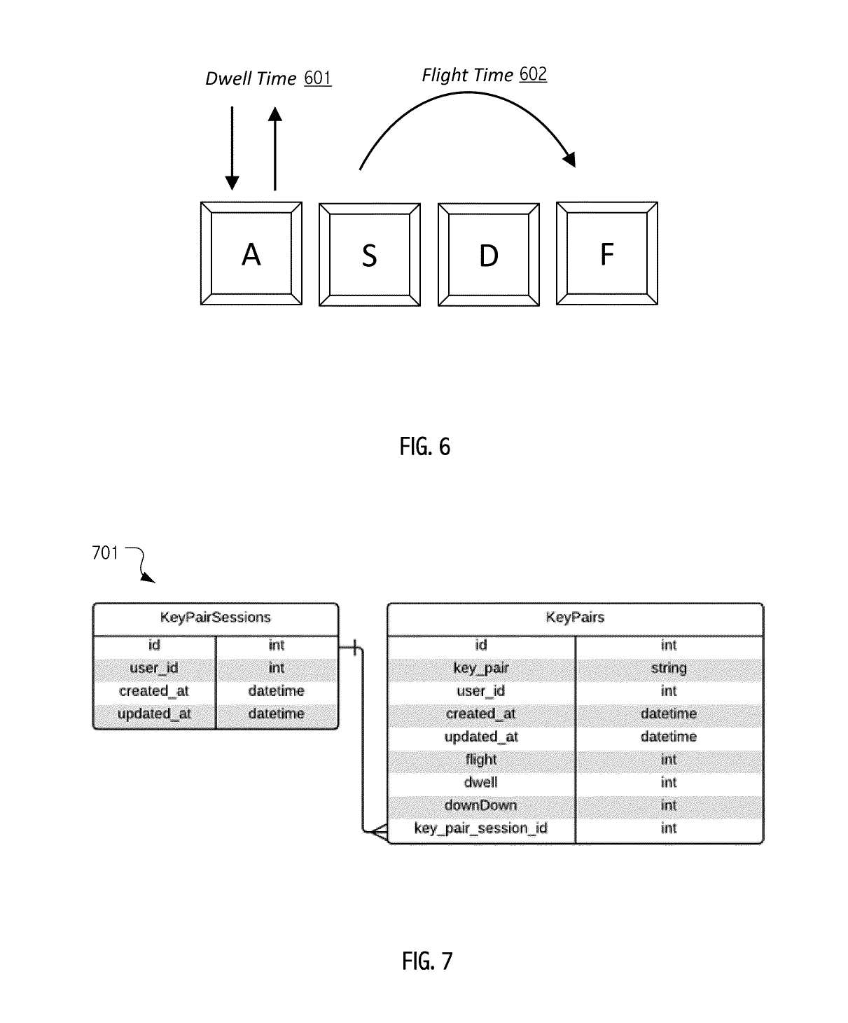

Turning now to FIG. 6, two examples of biometrically indicative data that may be extracted from keystroke data entered by an enrolling user are key press duration (dwell time 601) and key pair dependent timing (flight time 602). Other candidates for biometrically indicative data that may be employed include time between the previous key down and the current key down (down down timing), relative keystroke speed and certain classes of shift key usage. In an illustrative embodiment of key sequence timing-type feature extraction and classification 353 (recall FIG. 3), three keyboard biometric features are used for authentication:
Flight—The time between the previous key up and the current key down (this time may be negative if the last key is released after the current key press).
Dwell—The time the current key is depressed.
DownDown—The time between the previous key down and the current key down.

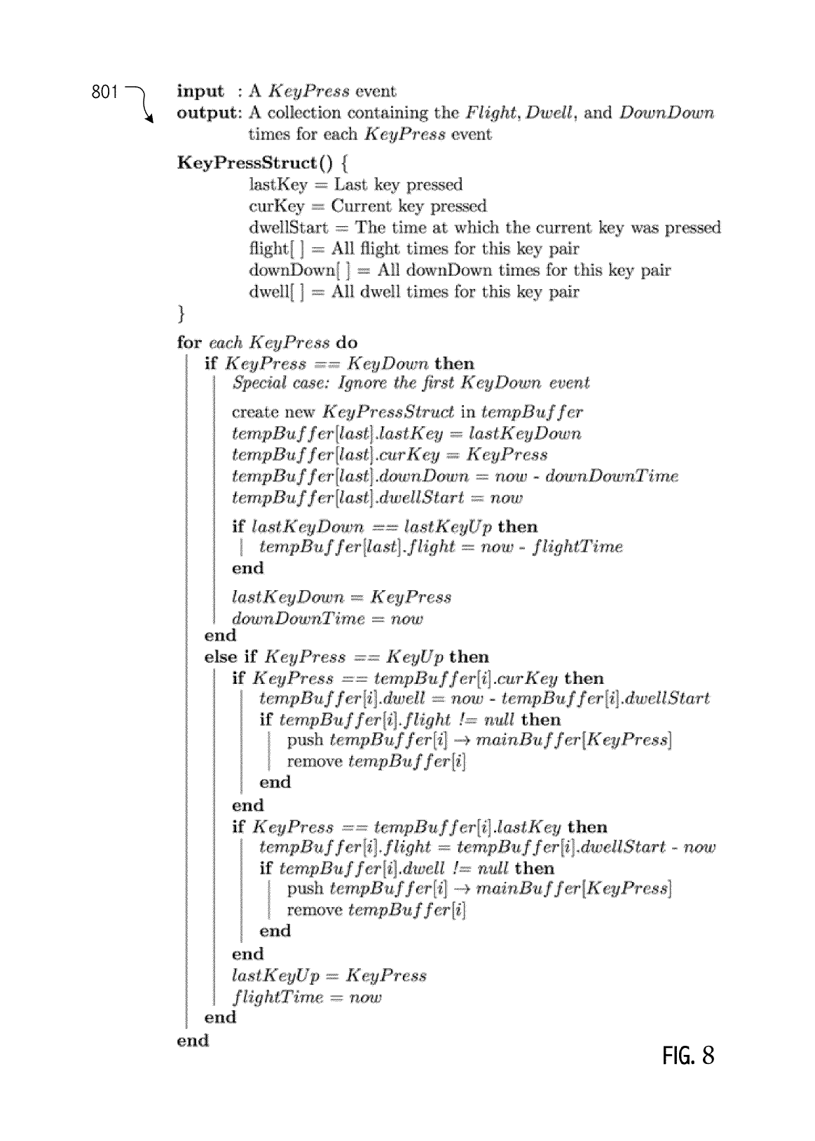

Key pairs and their features are collected in the following manner. The alphabet, numbers, space, shift, and commonly used punctuation keys are tracked. Pairs containing untracked keys may be disregarded by the analyzer. Pairs are stored in a KeyPair data structure 701, such as that illustrated in FIG. 7, which stores feature data. FIG. 8 depicts illustrative code suitable for key sequence timing-type feature extraction.

Two buffers are used in the process of key collection: one for storing incomplete KeyPairs (TempBuffer) and another to store completed KeyPairs (MainBuffer). When a user presses a key down, a new instance of KeyPair object 701 is created and the current key down, last key down, and timing data are stored (516) in it. This KeyPair is stored in the incomplete pair buffer. Positive values for the Flight feature may also be stored (516) at this point. When a user lets a key up, the incomplete pair buffer is scanned to see if it that key up completes a KeyPair. If it does, that KeyPair is stored (516) in the completed pairs buffer and removed from the incomplete pairs buffer. Negative Flight values may be stored (516) at this point. When the user finishes text input, a JSON file is created (517) with all the pairs' features which are extracted from the KeyPairs in the completed pair buffer. This JSON file is sent to the database 515.

Once a profile has been created, an anagram based authentication string is created (518) from the top 5%-10% of key pairs (by number of occurrence) or chosen from a list of phrases. The user is prompted to enter (518) the anagram. As before, keystroke data is captured at the user workstation and computationally-defined features for key pairs such as flight, dwell and downdown are computed (519) and communicated (520) for cloud- or server-resident classification (521) against distributions stored in database 515. In general, a rejected authentication brings the user back to the start of the loop (anagram entry 518) and may be repeated several times in case there was a false rejection. If the user is authenticated, then the additional keystroke data is added (522) to database 515. In some cases, situations or embodiments, the user's typed substantive responses in the context of a test, quiz or other coursework may be employed for authentication.

Turning more specifically to classifier operation of key sequence timing-type feature extraction and classification 353 (recall FIG. 3), classifier 521 can be understood as follows. When authenticating a user, there are two sets of pairs/features: the training set and the set to authenticate against that training set. A list of pairs contained in both sets is generated, and only those pairs are considered in the classification. Then, the mean and standard deviation of each feature of each pair in each set is generated. For each feature from each pair, the distance of the mean of the authentication set's feature from the training set's feature is taken, then normalized by the standard deviation of that feature from the training set. This distance is then weighted by multiplying it by the number of occurrences of the pair in the training set. We add up these values for each feature, and then divide by the total amount of pair occurrences. This generates a zScore statistical measure for each feature, without pair relation. These scores are then averaged, and the average is tested against a data derived threshold. The user is successfully authenticated if the score is less than the threshold. In some embodiments, zScore measures may be replaced with other distance metrics such as cosine or Manhattan distance.

### Vocal Features and Classification

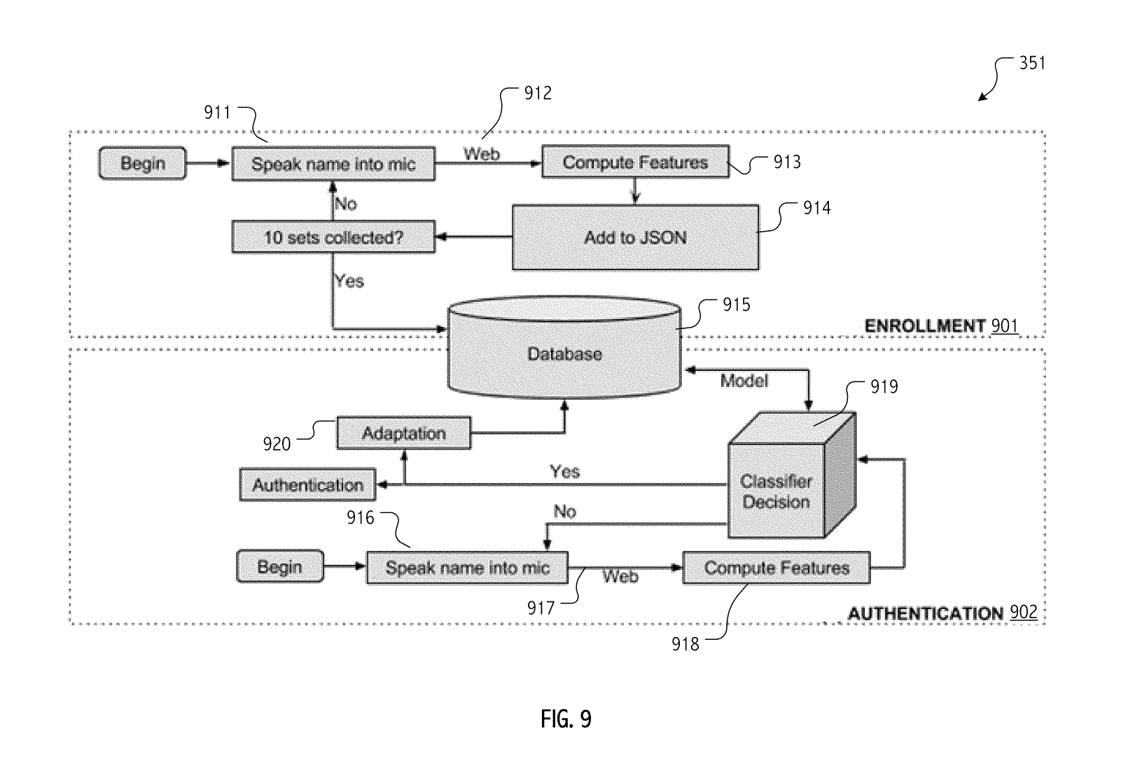

FIG. 9 is a flowchart depicting an algorithm executable in, or in connection with, voiceprint-type audio feature extraction and classification operations to authenticate identity of a particular user in the flows depicted in FIG. 3. As before, the algorithm includes both enrollment (901) and authentication (902) portions and, as before, initial capture of biometrically indicative data (here of Mel frequency cepstrum coefficients, MFCCs, and spectral subband centroids, SSCs) may be performed (at least in part) on a workstation-resident processor based on, for example, code that is demand-supplied from a cloud- or server-resident service platform.

A user creates a user profile and, as part of an enrollment phase 901 of audio feature extraction and classification 351, a web based application guides the user through the process of voicing (911) their name and/or a unique phrase multiple times into their computer's microphone. These utterances are sent (912) to cloud- or server-resident computations to have biometrically indicative, computationally-defined features extracted (913) and represented (914) in a JSON file and stored to database 915.

As part of certain coursework submissions 110 or in response to other non-coursework responses 311 (recall FIG. 3), the user is asked to once again voice (916) their name and/or a unique phrase into their microphone. IN some cases, situations or embodiments, the user voices a substantive response in the of a test, quiz or other coursework submission. In each case, the user's utterance is sent (917) to cloud- or server-resident computations that extract (918) computationally-defined features (the aforementioned MFCC- and SSC-type features) and compare (using classifier 919) those features against the enrollment model represented in database 915. A rejected authentication brings the user back to the start of the loop (vocal capture 916) and may be repeated several times in case there was a false rejection. If the user is authenticated, then the additionally extracted MFCC- and SSC-type feature data is added (920) to the training set in database 915 and the oldest example features are removed.

In an illustrative embodiment of the voiceprint-type audio feature extraction and classification 353 (recall FIG. 3) detailed in FIG. 9, three audio features are extracted (913, 918) from each utterance and used for authentication:
NFCCs—the coefficients of a Mel frequency cepstrum, which is a representation of the short-term power spectrum of a sound, based on a inear cosine transform of a log power spectrum on the nonlinear Mel scale of frequency.
SSCs—after dividing the FFT spectrum into a certain amount of subbands, the centroid of each subband is calculated.

The utterances are recorded as 22050 Hz 16 bit .ways, then run through an short-time Fourier transform (STFT) with an FFT size of 1024, a window length of 25 ms, and a step size of 10 ms. Twelve (12) MFCCs (and 1 extra features representing the total energy of the frame) and six (6) SSCs are extracted from each FFT frame. The MFCCs are generated with 26 filters, and the SSCs are generated with 6 filters/bands.

Turning more specifically to classifier operation of voiceprint-type audio feature extraction and classification 351 (recall FIG. 3), classifier 919 can be understood as follows. K-means clustering is used to create a “codebook” of centroids from the training set features. Then, using vector quantization, the distance of each feature (918) in the authentication set from the codebook is calculated, then averaged, and then normalized by the distance/distortion of the training features from the codes. The mean of all these normalized feature “distortions” give a distance metric. This is done separately for the MFCCs and SSCs. Then the two distance scores are averaged. If this average is below this threshold, the user is successfully authenticated. In some cases, situations or embodiments, alternative algorithms may be employed, such as convolutional neural nets using multiple layers and either 2-D or 1-D convolution kernels.

### Other Embodiments and Variations

While the invention(s) is (are) described with reference to various embodiments, it will be understood that these embodiments are illustrative and that the scope of the invention(s) is not limited to them. Many variations, modifications, additions, and improvements are possible. For example, while certain feature extraction and classification techniques have been described in the context of illustrative biometrically indicative data and authentication scenarios, persons of ordinary skill in the art having benefit of the present disclosure will recognize that it is straightforward to modify the described techniques to accommodate other techniques features and classifiers, other biometrically indicative data and/or other authentication scenarios.

Embodiments in accordance with the present invention(s) may take the form of, and/or be provided as, a computer program product encoded in a machine-readable medium as instruction sequences and other functional constructs of software, which may in turn be executed in a computational system to perform methods described herein. In general, a machine readable medium can include tangible articles that encode information in a form (e.g., as applications, source or object code, functionally descriptive information, etc.) readable by a machine (e.g., a computer, server, virtualized compute platform or computational facilities of a mobile device or portable computing device, etc.) as well as non-transitory storage incident to transmission of the information. A machine-readable medium may include, but is not limited to, magnetic storage medium (e.g., disks and/or tape storage); optical storage medium (e.g., CD-ROM, DVD, etc.); magneto-optical storage medium; read only memory (ROM); random access memory (RAM); erasable programmable memory (e.g., EPROM and EEPROM); flash memory; or other types of medium suitable for storing electronic instructions, operation sequences, functionally descriptive information encodings, etc.

In general, plural instances may be provided for components, operations or structures described herein as a single instance. Boundaries between various components, operations and data stores are somewhat arbitrary, and particular operations are illustrated in the context of specific illustrative configurations. Other allocations of functionality are envisioned and may fall within the scope of the invention(s). In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the invention(s).

1. A method comprising:
providing multimedia educational content to users in an internetworking environment;
authenticating identity of individual users at least in part by computationally processing key sequence timings captured in connection with passphrase responses unique to the individual users, wherein the passphrase for a particular individual user is structured to include key sequences for which timings were computationally determined to be characteristic of the particular user; and
determining compensation for either or both of contributors and sponsors of the provided educational content based at least in part on a compensation metric that is based on population of users whose identity has been authenticated at least in part by the computational processing of the key sequence timings.

2. A method comprising:
providing multimedia educational content to users in an internetworking environment, the multimedia educational content including coursework requiring, at least for a subset of the users, interactive responses;
authenticating identity of individual users at least in part by computationally processing audio features extracted from user vocals captured in connection with the interactive responses; and
determining compensation for either or both of contributors and sponsors of the provided educational content based at least in part on a compensation metric that is based on population of users whose identity has been authenticated at least in part by the computational processing of the audio features.

3. A method comprising:
providing multimedia educational content to users in an internetworking environment, the multimedia educational content including coursework requiring, at least for a subset of the users, interactive responses;
authenticating identity of individual users at least in part by computationally processing image processing features of images or video of the individual users captured in connection with the interactive responses; and
determining compensation for either or both of contributors and sponsors of the provided educational content based at least in part on a compensation metric that is based on population of users whose identity has been authenticated at least in part by the computational processing of the image processing features.

4. A method comprising:
providing multimedia educational content to users in an internetworking environment, the multimedia educational content including coursework requiring, at least for a subscribing subset of the users, interactive responses from the users;
authenticating identity of individual users from the subscribing subset of users at least in part by computationally processing at least one of (i) key sequence timings captured in connection with the interactive responses by the individual users, (ii) audio features extracted from user vocals captured in connection with the interactive responses and (iii) image processing features of images or video of the individual users captured in connection with the interactive responses; and
determining compensation for either or both of contributors and sponsors of the provided educational content based at least in part on a compensation metric that is based on population of users, from the subscribing subset thereof, whose identity has been authenticated at least in part by the computational processing of the key sequence timings, the captured audio features or the images or video captured in connection with the interactive responses.

5. The method of claim 4,
creating a passphrase for the particular user, wherein the created passphrase is structured to include key sequences for which timings were computationally determined to be characteristic of the particular user.

6. The method of claim 4,
wherein the population of users on which the compensation metric is based is a set of users determined, at least in part based on the interactive responses, to be active users.

7. The method of claim 6,
wherein the population of users on which the compensation metric is based excludes those users determined to be inactive.

8. The method of claim 6, further comprising determining the active set of users based on one or more of:
submission of assignments by the user;
completion of quizzes or tests; and
participation in user forums.

9. The method of claim 6, wherein the compensation metric includes allocation of a predetermined non-zero share of member or subscription fees to the contributors or sponsors of the provided educational content with respect to which a particular user is determined to be active.

10. The method of claim 6, wherein the compensation metric includes allocation of a predetermined non-zero share of fees to the contributors or sponsors of the provided educational content with respect to which a particular user is registered for credit.

11. The method of claim 4,
wherein the identity authenticating includes computationally evaluating correspondence of the captured key sequence timings with key sequence timings previously captured for, and previously determined to be, characteristic of a particular user.

12. The method of claim 11, further comprising:
capturing the key sequence timings for the particular user and
computationally determining particular ones of the key sequence timings to be characteristic of the particular user.

13. The method of claim 12,
wherein the key sequence timing capture is performed, at least in part, as part of enrollment of the particular user.

14. The method of claim 12, further comprising:
creating a passphrase for the particular user, wherein the created passphrase is structured to include key sequences for which timings were computationally determined to be characteristic of the particular user.

15. The method of claim 4,
wherein the identity authenticating includes computationally evaluating correspondence of the captured vocal features with vocal features previously captured for, and previously determined to be, characteristic of a particular user.

16. The method of claim 15 further comprising:
capturing the vocal features for the particular user and computationally determining particular ones of the vocal features to be characteristic of the particular user.

17. The method of claim 16,
wherein the vocal feature capture is performed, at least in part, as part of enrollment of the particular user.

18. The method of claim 4,
wherein the identity authenticating includes computationally evaluating correspondence of the captured image processing features with features previously captured for, and previously determined to be, characteristic of a particular user.

19. The method of claim 18, further comprising:
capturing the image processing features for the particular user and computationally determining particular ones of the image processing features to be characteristic of the particular user.

20. The method of claim 19,
wherein the image processing feature capture is performed, at least in part, as part of enrollment of the particular user.

21. The method of claim 19, further comprising:
providing the particular user with an on-screen game or task, the on-screen game or task providing a user interface mechanism by which movement, by the particular user, of his or her face within a field of view of visual capture device is used to advance the particular user through the on-screen game or task; and
during the on-screen game or task capturing the image processing features.

22. The method of claim 4, wherein the identity authentication is multi-modal.

23. The method of claim 4, further comprising:
computationally evaluating correspondence of at least some of the captured image processing features with captured vocals.

24. The method of claim 4, wherein the compensation metric allocates either or both of member/subscription fees and tuition.

25. The method of claim 4, wherein the contributors include educational content originators and/or instructors.

26. The method of claim 4, wherein the sponsors include educational institutions, testing organizations and/or accreditation authorities.

27. The method of claim 4, further comprising:
compensating either or both of the contributors and sponsors based on the determined compensation metric.

28. (canceled)

29. (canceled)

30. (canceled)

31. A learning management system comprising:
one or more multimedia educational content stores that are network-accessible and configured to serve a distributed network-connected set of content delivery devices with multimedia educational content including interactive content requiring, at least for a subscribing subset of the users, interactive responses;
a biometrically-based user authentication mechanism for authenticating identity of individual users from the subscribing subset of users at least in part by computationally processing one or more of (i) key sequence timings, (ii) audio features extracted from user vocals and (iii) image processing features of images or video of the individual users, each captured, for a respective user from the subscribing subset of users, at a respective content delivery device in connection with the interactive responses by the respective user to the multimedia educational content served from the network-accessible content stores;
an administration module configured to maintain records data for individual users from the subscribing subset of users and coupled to receive from the biometrically-based user authentication mechanism indications that, in the course of interactive responses by respective users to the multimedia educational content served from the network-accessible content stores, particular users from the subscribing subset of users have been authenticated,
wherein the administration module is further configured to determine compensation for either or both of contributors and sponsors of the served educational content based on a compensation metric that is based at least in part on an active population of users, from the subscribing subset thereof, whose identity has been authenticated at least in part by the computationally processing of the key sequence timings, the captured audio features or the images or the video captured in connection with the interactive responses.
